(19) United States
(12) Patent Application Publication
(10) Pub. No.: US 2015/0013517 A1
(43) Pub. Date: Jan. 15, 2015

(54) Device for cutting harvested asparagus spears or other elongated food products

(71) Applicants: Hermann Neubauer, Welver (DE); Christoph Neubauer, Welver (DE)

(72) Inventors: Hermann Neubauer, Welver (DE); Christoph Neubauer, Welver (DE)

(21) Appl. No.: 14/382,318

(22) PCT Filed: Mar. 1, 2013
(86) PCT No.: PCT/EP2013/054182

§ 371 Date: Aug. 31, 2014

(30) Foreign Application Priority Data
Mar. 2, 2012 (DE) 10 2012 004 062.8

(51) Int. Cl. A23N 7/04

(52) U.S. Cl. CPC A23N 7/04
USPC 83/402

(57) ABSTRACT

Device for cutting harvested asparagus spears or other elongated food products, with cutting means (11) capable of producing a jet, especially a water jet (13), for cutting the asparagus spears or the other elongated food products, with which the asparagus spears or the other elongated food products can be cut, as well as deflection means (15) for interrupting of the jet, which are constructed so as to be movable while deflecting the jet.

The present invention relates to a device for cutting harvested asparagus spears according to the preamble of claim 1.

A device of the aforementioned type is known from DE 10 2010 025 026. Therein, a pin made of a hard metal serving as a deflection element is disclosed. Disadvantageously, the pin of this device shows inacceptable high wear after only a short time in spite of the selected hard material, because the water jet removes material from its surface. For this reason, the deflection element must be replaced after a relatively short period of use.

The problem underlying the present invention is to provide a device of the aforementioned type, which has a greater service life.

This is attained by the invention with a device of the aforementioned type having the characterizing features of claim 1. The dependent claims relate to preferred embodiments of the invention.

According to claim 1, the deflection means is constructed to be movable while deflecting the jet. Due to the movability, the part of the surface of the deflection element hit by the jet can evade the jet so that the surface of the deflection element is not damaged only slightly or not at all. The service life of the system is hereby significantly increased.

For example, the deflection means may perform a rotational and/or translational motion while the jet is being deflected.

For this purpose, the deflection means may include a rotatable and/or displaceably supported or mounted deflection element, which may have for example a cylindrical shape. However, other shapes of the deflection element are also possible. For example, the deflection element may also be spherical or disk-shaped. Other configurations are possible, in particular, those which allow a rotation.

In particular, at least the surface of the deflector may at least in sections be made of a hard metal or a material having a similar hardness.

Instead of asparagus spears, other elongated food products can also be cut with the device according to the invention, in particular for example carrots or cucumbers.

Other features and advantages of the present invention will become apparent from the following description of preferred exemplary embodiments with reference to the accompanying drawings, which show in

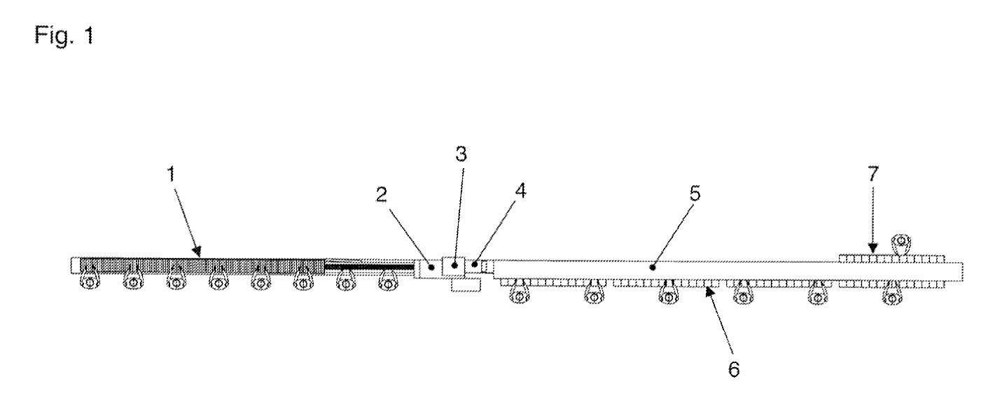

FIG. 1 a schematic plan view of a device according to the invention for cutting harvested asparagus spears;

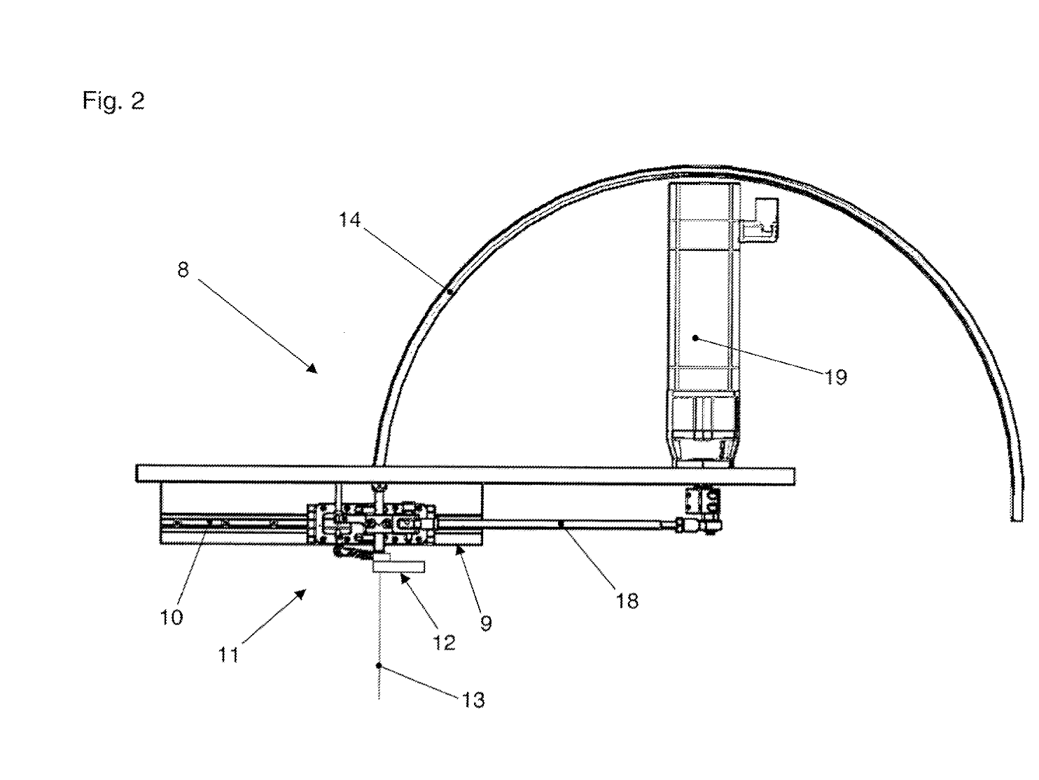

FIG. 2 a detailed schematic view of the cutting means;

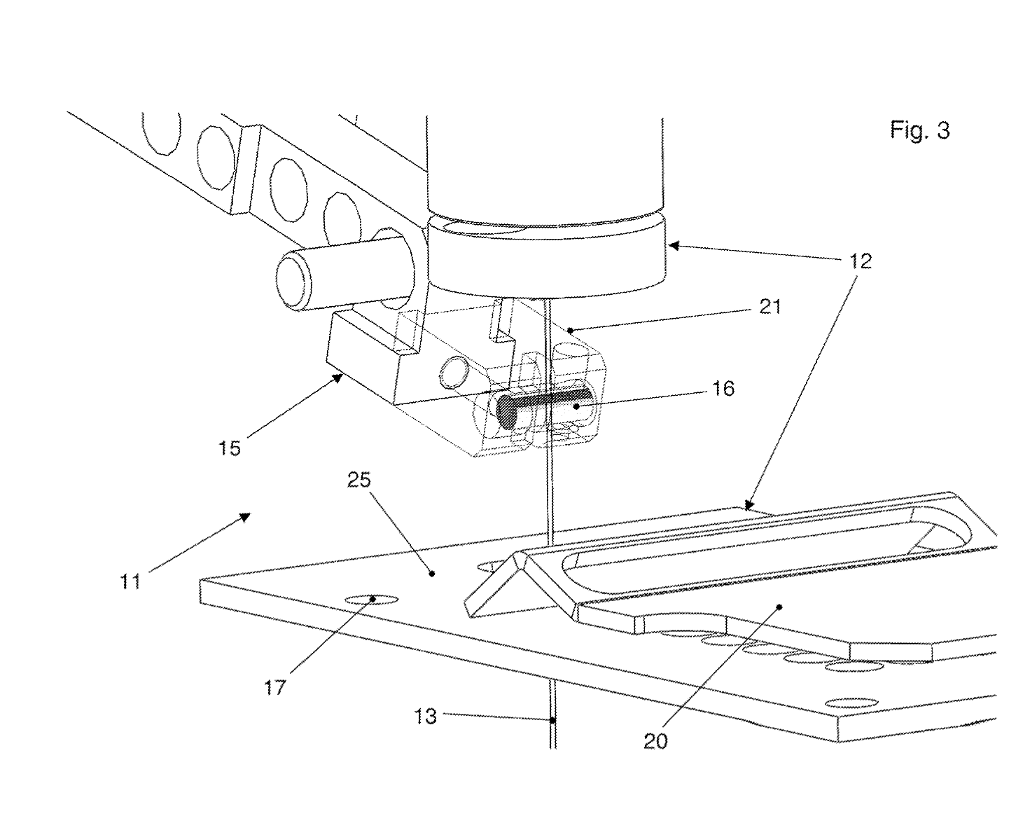

FIG. 3 a detailed view of the deflection means; and

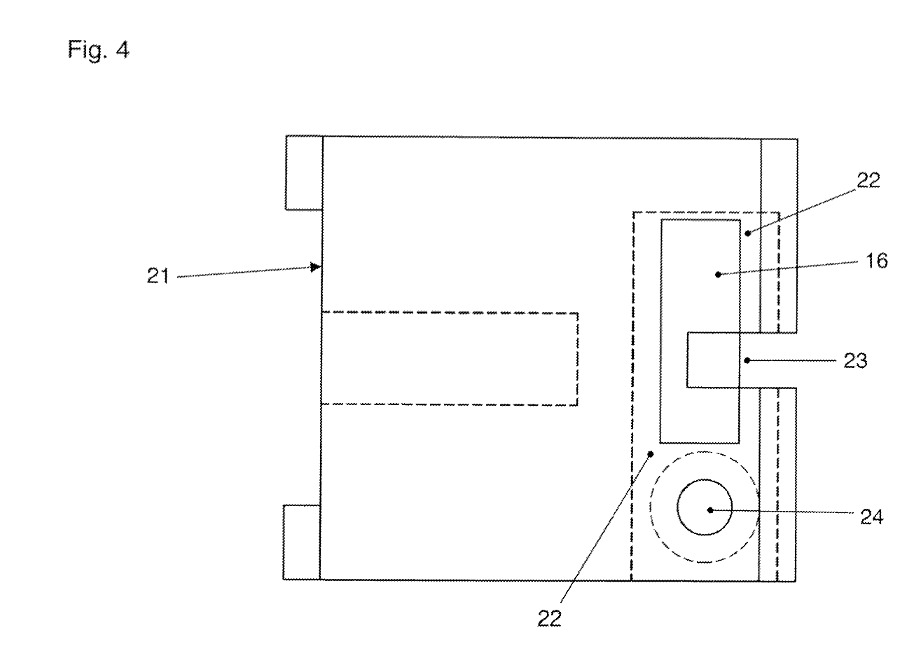

FIG. 4 a top view of the pin holder of the deflection means.

The device according to the invention allows the effective selective cutting of asparagus spears. In particular, a method is provided which makes it possible to cut unsorted asparagus to any length, for example, in an automatic asparagus sorting machine.

However, other elongated food products, in particular for example carrots or cucumbers, can also be cut with a device according to the invention. Although asparagus spears may be explicitly mentioned hereinafter, the illustrated parts of the device should also be suitable for cutting other elongated food products.

The device 1, schematically depicted in FIG. 1, includes a support region 1, on which the asparagus spears can be placed. The asparagus spears may also be separated particularly in this region. The asparagus spears are conveyed by an unillustrated conveyor belt serving as feed means from this support region 1 to a precutting and washing unit 2.

A measuring and cutting area 3, where both a first camera and a cutting unit are arranged, is located downstream of the precutting and washing unit 2. The asparagus spears rest on the conveyor belt so that the longitudinal direction of the asparagus spears coincides with the transverse direction of the conveyor belt, or equivalently so that the asparagus spears are oriented perpendicular to the conveying direction.

The data collected by the first camera are processed by a computer unit, which determines the sorting class of the asparagus (such as length, thickness, bud, etc.) of an asparagus spear detected by the first camera. The data obtained in this way are used to control the cutting unit, which is capable of cutting each asparagus spear to a defined length. It is immaterial here whether the asparagus is straight or curved. The stretched length is accurately determined from the data captured by the first camera by using corresponding algorithms.

A second camera 4 or other suitable measuring means which permit control of the cutting operation are provided downstream of the measuring and cutting region 3.

A sorting and output region 5 is arranged downstream thereof, which may have a plurality of output bins, preferably more than 10, especially more than 30, for example 56 output bins. In particular, the output bins may be provided with weighing units 6 so as to allow combining of asparagus spears into bundles having a predetermined weight.

The asparagus spears can be sorted in this sorting and output region 5 depending on properties that are determined by a computer from the data determined by the first camera and/or the second camera 4. Another optional output region is designated in FIG. 1 by the reference symbol 7.

The cutting unit shown 8 in detail in FIG. 2 includes a carriage 9 which is movable in the transverse direction on a guide rail 10, in particular perpendicular to the conveying direction of the conveyor belt supplying the asparagus spears. The carriage 9 thus moves in the longitudinal direction of the asparagus spears resting on the conveyor belt.

The cutting unit 8 further includes cutting means 11 formed as a water jet cutting device. FIG. 2 and FIG. 3 show the outlet nozzle 12 of the water jet cutting device, from which the water jet 13 that is used for cutting exits. The outlet nozzle 12 is connected via a hose 14 to an unillustrated high-pressure pump.

The cutting unit 8 further includes deflection means 15 capable of interrupting the water jet 13. For this purpose, the deflection means 15 have a pin made of a hard metal and serving as a deflection element 16 which can be moved under computer-control into the water jet 13 (see FIG. 3). The water jet 13 is split at the pin and impinges on a baffle plate 20 provided at the bottom 25 of the outlet nozzle 12 (see FIG. 3).

The baffle plate 20 has a partially folded or domed structure. Furthermore, the baffle plate 20 is surrounded by the side walls of the outlet nozzle 12 (not illustrated in FIG. 3) which prevents the jet from exiting sideways. In this way, drops, which can escape downward through openings 17 in the bottom 25 of the outlet nozzle 12, are formed in the outlet nozzle form 12 when the jet is deflected.

The pin serving as a deflection element 16 is supported in a pin holder 21 visible in FIG. 3 and FIG. 4. The pin holder 21 has for this purpose a hollow cylindrical receptacle 22, which is larger than the pin both in the axial and in the radial direction. The pin serving as deflection element 16 can thus not only rotate in the receptacle 22, but also dodge in different directions when being hit by the water jet 13.

The pin holder 21 has a recess 23 through which the water jet 13 can pass and impinge on the pin serving as the deflection element 16. Furthermore, the pin holder 21 has a threaded bore 24 into which an unillustrated set screw can be screwed, which can limit the receptacle 22 in the axial direction.

The water jet 13 must be interrupted when the cutting unit 8 moves so as to prevent asparagus spears located underneath the water jet 13 from being unintentionally cut.

A rod 18 which is connected eccentrically to a servo motor 19 is mounted on the carriage 9. By appropriate control of the servo motor 19, the carriage 9 can be positioned with very high accuracy in the transverse direction of the conveyor belt. Instead of a single cutting unit 8, several cutting units 8 successively arranged in conveying direction may be employed. This can be quite useful at a high conveying speed, because otherwise the speed at which the carriage must be moved 9 would be too large.

In the illustrated cutting unit 8, the water jet 13 exiting from the cutting means 11 can be moved to a desired position in the transverse direction depending on the captured data and the sorting classes of the asparagus determined therefrom. In this way, each asparagus spear can be selectively cut. This means that for different asparagus spears the locations at which the asparagus spears are cut are different depending on the sorting classes or other suitable criteria.

Alternatively, instead of moving the at least one cutting unit 8 relative to the asparagus spears or relative to the conveyor belt on which the asparagus spears rest in the transverse direction of the conveyor belt or in the longitudinal direction of the asparagus spears, the asparagus spears may be moved relative to the at least one cutting unit 8 in the transverse direction of the conveyor belt or in the longitudinal direction of the asparagus spears.

This may be accomplished, for example, by shifting the asparagus spears in the transverse direction of the conveyor belt or in its longitudinal direction on the conveyor belt. This can be accomplished with sliders or vibrating means or the like. Alternatively, a part of the conveyor or the entire conveyor belt may be moved in the transverse direction.

It is also conceivable to combine a relative movement of the at e one cutting unit 8 with a relative movement of the asparagus spears.

It is also conceivable to provide in a device according to the invention positioning means capable of positioning the asparagus spears relative to the cutting means with respect to the longitudinal direction of the asparagus spears and/or capable of positioning the cutting means spears relative to the asparagus spears with respect to the longitudinal direction of the asparagus spears, while using as the cutting means at least one knife. In particular, when the asparagus spears and/or at least parts of the conveyor belt are moved, fixed knives, in particular rotary knives, can be quite practical.

1-5. (canceled)

6. A device for cutting harvested asparagus spears or other elongated food products, comprising
a cutter (11) for cutting the asparagus spears or the other elongated food products, wherein the cutter produces a jet (13), with which the asparagus spears or other elongated food products is cut, and a deflector (15) for interrupting the jet,
wherein the deflector (15) is constructed such that the deflector is movable while deflecting the jet.

7. The device according to claim 6, wherein the deflector performs a rotation and/or translation motion while deflecting the jet.

8. The device according to one of the claims 6, wherein the deflector (15) comprises a rotatably and/or movably supported or retained deflection element (16).

9. The device according to claim 8, wherein the deflection element (16) has a cylindrical or a spherical or disk-shaped configuration.

10. The device according to claim 6, wherein the deflection element (16) includes a surface and wherein the surface is at least partially composed of a hard metal or a material having a similar hardness.

11. The device according to claim 6, wherein the jet is a water jet.

12. The device according to claim 6, wherein the parts and wherein at least one part performs the rotation and/or translation motion while deflecting the jet.
